(19) United States
(12) Patent Application Publication
(10) Pub. No.: US 2021/0189060 A1
(43) Pub. Date: Jun. 24, 2021

(54) POLYURETHANE HAVING IMPROVED HARDNESS

(71) Applicant: Covestro Intellectual Property GmbH & Co. KG, Leverkusen (DE)

(72) Inventors: Hans Georg Grablowitz, Köln (DE); Hartmut Nefzger, Pulheim (DE); Olaf Fleck, Bergisch Gladbach (DE)

(21) Appl. No.: 17/269,291

(22) PCT Filed: Aug. 21, 2019
(86) PCT No.: PCT/EP2019/072373

§ 371 Date: Feb. 18, 2021

(30) Foreign Application Priority Data
Aug. 24, 2018 (EP) 18190762.7

(51) Int. Cl. C08G 63/16; C08G 18/79; C08G 18/42

(52) U.S. Cl. CPC C08G 63/16; C08G 18/4238; C08G 18/792

(57) ABSTRACT

The invention relates to polyester polyols of particular purity and to the use thereof for preparing polyurethanes having improved properties, in particular improved hardness.

The present invention relates to polyester polyols having particular purity and their use for producing polyurethanes having improved properties, in particular having an improved hardness.

Polyurethanes are a class of polymers which are well known to a person skilled in the art. They are produced by the addition reaction of polyhydric alcohols with polyisocyanates. Many compounds having at least two hydroxyl groups per molecule are in principle suitable as polyhydric alcohols.

They can be monomeric compounds such as glycerol. However, polyhydric alcohols which are themselves polymers are of greater industrial and economic importance. In particular, use is made of polycarbonate polyols, polyester polyols, polyether polyols, polyether carbonate polyols or polyether esters.

Polycarbonate polyols are obtained by a condensation reaction of low molecular weight carbonates and low molecular weight polyhydric alcohols. The molar ratio of carbonate to polyol here determines the molar mass of the polycarbonate polyol. In order to obtain hydroxyl-functional end products, a molar excess of polyol is used. The low molecular weight alcohol used frequently contains impurities. Thus, 1,6-hexanediol frequently also contains 1,4-cyclohexanediol.

When these impurities are incorporated into the polyol, products which also have secondary OH groups in addition to primary OH groups are formed.

EP 2 213 696 has shown that a high proportion of bi-products having secondary hydroxyl groups leads to the polyurethanes produced from the corresponding polycarbonate having a low tear strength and a low stability toward oleic acid. An appreciable influence of the proportion of secondary hydroxyl groups in the polycarbonate polyol on the hardness of the polyurethane produced therefrom is not discernible.

Polyester polyols are produced by a condensation reaction of polybasic carboxylic acids and polyhydric alcohols. The ratio of the amount of the two components is selected so that there is a molar excess of hydroxyl groups in the reaction mixture and the polymer formed therefore has free, terminal hydroxyl groups. Polyester polyols customarily used for producing polyurethanes have a number average molecular weight in the range from 500 to 4000 g/mol and an average OH functionality in the range from 1.8 to 3.5. However, they can also have molecular weights below 500 and above 4000 Da; likewise functionalities of less than 1.80 and above 3.5. Customary polyester polyols and suitable production processes are described in M. Ionescu, Chemistry and Technology of Polyols for Polyurethanes, Rapra Technology Ltd., Shawbury 2005, chapters 8 and 16 or J. H. Saunders and K. C. Frisch in Polyurethanes, Chemistry and Technology, Part I Chemistry, Inscience Publishers John Wiley & Sons, New York, 1962, chapter II. In this process too, polyols having secondary OH groups can be formed as described above as a result of the presence of impurities in the alcohols.

The study on which the present patent application is based has surprisingly shown that in the production of polyurethanes using polyester polyols, the hardness of the product formed is also quite significantly influenced by the proportion of the secondary hydroxyl groups in the polyester polyols. A consistent influence on the tear strength as described in EP 2 213 696 was not able to be observed, contrary to expectations.

The present patent application therefore provides polyester polyols having a low content of secondary hydroxyl groups, and also provides for the use of these for producing polyurethanes having an improved hardness.

In a first embodiment, the present invention provides a polyester polyol having a proportion of secondary OH groups based on the total amount of the terminal OH groups of not more than 5%.

The polyester polyols have OH numbers of from 18 to 300 mg KOH/g and consist to an extent of at least 95% by weight, preferably at least 98% by weight, of bifunctional formative components.

The balance to 100% by weight can be made up of more than bifunctional, for example, trifunctional or tetrafunctional, or else monofunctional components, with mixtures of, for example, trifunctional and tetrafunctional formative components of course being possible.

Examples of trifunctional formative components are glycerol, 1,1,1-trimethylolpropane, pentaerythritol, 1,2,3-benzenetricarboxylic acid, 1,3,5-benzenetricarboxylic acid, 1,2,4-benzenetricarboxylic acid, malic acid and tartaric acid.

However, particular preference is given in the context of the present invention to polyester polyols obtainable from exclusively bifunctional formative components.

Individual formative components or a plurality of the formative components can be bio-based, i.e. have been produced from renewable raw materials and/or by means of at least one fermentation step.

Formative components used for the polyester polyols of the invention are
a.) at least one aromatic and/or aliphatic dicarboxylic acid and/or dicarboxylic acid equivalent and
b) at least one linear and/or branched aliphatic diol having exclusively primary hydroxyl groups and/or, optionally,
c) at least one aliphatic hydroxycarboxylic acid having a primary hydroxyl group, which can also be present in the form of a lactone.

As formative component a), it is in principle possible to use all aliphatic and/or aromatic dicarboxylic acids having from 4 to 12 carbon atoms and also the anhydrides or low molecular weight diesters thereof as dicarboxylic acid equivalents.

As formative component b), it is in principle possible to use all aliphatic diols having from 2 to 14 carbon atoms. The aliphatic diols having from 2 to 14 carbon atoms are linear, but can also have one or more alkyl side chains.

Examples of suitable formative components a) are: phthalic acid, isophthalic acid, terephthalic acid, tetrahydrophthalic acid, hexahydrophthalic acid, cyclohexanedicarboxylic acid, succinic acid, glutaric acid, adipic acid, azelaic acid, sebacic acid, tetrachlorophthaic acid, maleic acid, succinic acid, fumaric acid, suberic acid, nonanedicarboxylic acid, decanedicarboxylic acid, dodecanedicarboxylic acid, 2-methysuccinic acid, 3,3-diethylglutaric acid and 2,2-dimethylsuccinic acid. It is also possible to use analogous anhydrides and/or low molecular weight diesters, which for the purposes of the present invention will be referred to as dicarboxylic acid equivalents, as acid source.

Particularly suitable components a) are linear, unbranched dicarboxylic acids having from 4 to 10 carbon atoms, adipic acid, succinic acid, phthalic acid, isophthalic acid and terephthalic acid and also the dicarboxylic acid equivalents of the abovementioned compounds. Examples which may be mentioned are: phthalic anhydride, succinic anhydride, dimethyl terephthalate, diethyl terephthalate.

Examples of suitable formative components b) are: ethylene glycol, 1,3-propanediol, 1,4-butanediol, 1,5-pentanediol, 1,6-hexanediol, 1,7-heptanediol, 1,8-octanediol, 1,9-nonanediol, 1,10-decanediol, 1,11-undecanediol, 1,12-decanediol, 2-methylpropane-1,3-diol, 2,2-dimethylpropane-1,3-diol, 3-methylpentane-1,5-diol.

Particularly suitable components b) are linear, unbranched diols having from 2 to 12 carbon atoms selected from the group consisting of ethylene glycol, 1,3-propanediol, 1,4-butanediol, 1,5-pentanediol, 1,6-hexanediol, 1,10-decanediol, 1,12-decanediol and 2,2-dimethylpropane-1,3-diol.

Possible components c) are linear, unbranched hydroxycarboxylic acids having >6 and 10 carbon atoms. 6-hydroxycaproic acid and ε-caprolactone are particularly preferred.

As is generally known, the molar ratios of the components a), b) and optionally c) determine the average degree of polymerization of the polyester polyols. The components in any case need to be combined in such a way that the number of hydroxyl groups used exceeds the number of carboxyl groups used.

The polyester polyols are produced by polycondensation in a manner known per se. The procedure here can be to initially charge the components a), b) and optionally c) together; however, they can also be used in a plurality of stages.

Possible catalysts are in principle all catalysts known for the production of polyesters. These are, for example, tin salts, e.g. tin dichloride, titanates, e.g. tetrabutyl titanate, bismuth salts, e.g. bismuth acetate and bismuth neodecanoate, or strong acids, e.g. p-toluenesulfonic acid and sulfuric acid. However, the polyesters can also be produced without use of catalysts.

The polyesters are normally produced without using a solvent. However, they can also be produced with addition of a solvent, in particular a water-entraining solvent (azeotropic esterification), for example benzene, toluene or dioxane. The removal of the water of reaction in the solvent-free variant is normally assisted by application of a subatmospheric pressure, in particular toward the end of the esterification. Pressures of from 1 to 500 mbar are employed here. However, esterification is also possible above 500 mbar. The removal of the water of reaction can in this case also be assisted by passage of an inert gas, for instance nitrogen or argon, through the mixture.

The reaction is carried out at elevated temperature. Reaction temperatures of from 100 to 250° C., preferably from 160 to 230° C., are customary in the solvent-free variant. In the azeotropic esterification, the reaction temperature is determined by the type and amount of the entrainer and is usually in the range from 100 to 180° C.

The reaction is carried out to a conversion at which the acid number of the polyester polyols according to the invention is not more than 10, preferably not more than 5, particularly preferably not more than 2 and very particularly preferably <1 mg KOH/g.

The proportion of secondary hydroxyl groups based on the total amount of hydroxyl groups present in the polyester polyol is not more than 5 mol %, preferably not more than 2 mol % and even more preferably 1 mol %.

The proportion is preferably determined by means of ¹³C-NMR at a measurement frequency of 151.0 MHz in d1-chloroform. The proportion of primary hydroxyl groups (CH₂—OH) is preferably determined according to the following formula:

Proportion of CH₂—OH=A(CH₂—OH signal)/(A(CH₂—OH signal)+A(CH—OH signal))*100%

Here, A is the area of the respective signal in the NMR spectrum and CH—OH represents secondary OH groups.

A particularly preferred, complete measurement method is disclosed in the working examples.

In order to obtain polyester polyols having the low content of secondary hydroxyl groups which is required according to the invention, sufficiently pure alcohols have to be used for producing the polyester. The suitability of an alcohol for producing a polyester polyol which is suitable for the purposes of the invention can be checked by conventional analytical methods such as gas chromatography or high performance liquid chromatography.

In the study on which the present invention is based, it was surprisingly found that contamination of the alcohol used for producing the polyester polyol with compounds containing second OH group leads to a disproportionately large increase in the proportion of secondary OH groups in the product. Thus, a proportion of 4.3 mol % of 1,4-cyclohexanediol based on the total amount of hexanediol and 1,4-cyclohexanediol led to a proportion of 8 mol % of secondary OH end groups in the polyester.

For this reason, the proportions of all polyols having at least one secondary OH groups in the reaction mixture used for producing the polyester polyol are in each case preferably not more than half the value sought in each case for the finished polyester polyol in order to adhere to the abovementioned proportions of secondary OH end groups of 5.0 mol %, 2.0 mol % and 1.0 mol % based on the total amount of OH end groups of the polyester polyol. In the case of the abovementioned maximum values in the polyester polyol, this means upper limits of not more than 2.5 mol %, not more than 1.0 mol % and not more than 0.5 mol %, respectively. Particular preference is given to the sum of the proportions of 1,4-cyclohexanediol, 2,2,4-trimethylpentane-1,3-diol and 2,3-dihydroxybutanediol not exceeding the abovementioned values.

Polymerizable Composition

In a further embodiment, the present invention provides a polymerizable composition containing at least one polyester polyol having the maximum content as defined above in the present patent application of secondary OH groups based on the total amount of the terminal OH groups present and at least one polyisocyanate.

All definitions given above for the polyester polyol also apply to this embodiment.

Isocyanate

The term “polyisocyanate” refers to molecules having an average isocyanate functionality of at least 2. Suitable polyisocyanates are aromatic, araliphatic, aliphatic or cycloaliphatic polyisocyanates. It is also possible to use mixtures of such polyisocyanates. Preferred polyisocyanates are selected from the group consisting of butylene diisocyanate, hexamethylene diisocyanate (HDI), pentamethylene 1,5-diisocyanate (PDI), isophorone diisocyanate (IPDI), 2,2,4 and/or 2,4,4-trimethylhexamethylene diisocyanate, the isomeric bis(4,4′-isocyanatocyclohexyl)methanes or mixtures thereof having any isomer content, isocyanatomethyloctane 1,8-diisocyanate, cyclohexylene 1,4-diisocyanate, phenylene 1,4-diisocyanate, tolylene 2,4- and/or 2,6-diisocyanate, naphthylene 1,5-diisocyanate, diphenylmethane 2,4′- or 4,4′-diisocyanate, triphenylmethane 4,4′,4″-triisocyanate and derivatives thereof having a urethane, isocyanaurate, allophanate-, biuret, uretdione or iminooxadiazinedione structure. Mixtures thereof are also preferred. Particular preference is given to hexamethylene diisocyanate, isophorone diisocyanate and the isomeric bis(4,4′-isocyanatocyclohexyl)methanes and also mixtures thereof.

Ratio of NCO:OH

The polymerizable composition is preferably characterized in that the molar ratio of isocyanate groups to hydroxyl groups of the at least one polyester polyol is in the range from 0.7:1.0 to 2.5:1.0, more preferably from 0.8:1.0 to 2.0:1.0 and even more preferably from 0.9:1.0 to 1.8:1.0.

Catalyst

The polymerizable composition of the invention preferably additionally contains at least one catalyst which accelerates the formation of urethane groups from hydroxyl and isocyanate groups. For this purpose, it is possible to use all urethanization catalysts known to a person skilled in the art, for example metal-organic compounds and tertiary amines. Particular preference is given to tin dioctoate, dibutyltin dilaurate, triethylamine, 1,4-diazabicyclo[2,2,2]octane and bismuth dioctoate.

Use

In still a further embodiment the present invention provides for the use of a polyester polyol or a polymerizable composition as defined above in the present patent application for producing a polyurethane polymer.

All definitions given above for the polyester polyol and the polymerizable composition also apply to this embodiment.

Particular preference is given to the use of a polyester polyol or a polymerizable composition for producing a polyurethane polymer having a particularly high hardness. Here, “particularly high hardness” refers to the improvement in the hardness of the polyurethane polymer produced according to the invention, compared to polyurethane polymers produced from polyester polyols having a higher proportion of secondary hydroxyl groups. In particular, a polyurethane polymer produced using a polyester polyol according to the invention which is characterized by a proportion of secondary hydroxyl groups based on the total amount of terminal hydroxyl groups of not more than 2 mol % has a Shore D hardness which is at least 3 mol % greater than the hardness of a polyurethane polymer produced using a polyester polyol having a content of secondary hydroxyl groups of at least 5 mol % of the totality of the terminal hydroxyl groups. The Shore D hardness is preferably measured in accordance with DIN ISO 7619-1, February 2012 version.

In a particularly preferred embodiment of the present invention, the alcohol component of the polyester polyol consists to an extent of at least 90% by weight, more preferably at least 95% by weight, of 1,6-hexanediol. Here, the polyurethane polymer has a Shore D hardness which is at least 8% above the value measured when using an otherwise identical polyester polyol having a proportion of second OH groups based on the total amount of terminal OH groups of at least 5 mol %.

In a further particularly preferred embodiment of the present invention, the alcohol component of the polyester polyol consists to an extent of at least 90% by weight, more preferably at least 95% by weight, of 1,6-hexanediol. Here, the polyurethane polymer has a König pendulum hardness which is at least 5% above the value measured when using an otherwise identical polyester polyol having a proportion of secondary OH groups based on the total amount of terminal OH groups of at least 5 mol %.

In a further particularly preferred embodiment of the present invention, the alcohol component of the polyester polyol consists to an extent of at least 90% by weight, more preferably at least 95% by weight, of 1,4-butanediol. Here, the polyurethane polymer has a Shore D hardness which is at least 3% above the value measured when using an otherwise identical polyester polyol having a proportion of secondary OH groups based on the total amount of terminal OH groups of at least 5 mol %.

In a further particularly preferred embodiment of the present invention, the alcohol component of the polyester polyol consists to an extent of at least 90% by weight, more preferably at least 95% by weight, of 1,4-butanediol. Here, the polyurethane polymer has a Konig pendulum hardness which is at least 4% above the value measured when using an otherwise identical polyester polyol having a proportion of secondary OH groups based on the total amount of terminal OH groups of at least 5 mol %.

Process

In still a further embodiment, the present invention provides a process for producing polyurethane polymers having a particularly high hardness, comprising the steps
a) mixing of a polyester polyol having a proportion of secondary hydroxyl groups based on the total amount of terminal hydroxyl groups of not more than 2% with at least one polyisocyanate;
b) reaction of the mixture to give a polyurethane.

All definitions given for the embodiments disclosed above also apply to the process of the invention.

The mixing of polyester polyol and polyisocyanate in process step a) can be carried out using all methods known to a person skilled in the art. The product of process step a) is the polymerizable composition defined further above in the present patent application.

The processes for reaction of a polymerizable composition to give a polyurethane are well known to a person skilled in the art. It is possible to use all processes which are known from polyurethane chemistry and are suitable for the specific polymerizable composition. The reaction of the polyester polyol with the polyisocyanate to give a polyurethane can be carried out in various ways, for example by heating the mixture in a reaction vessel until a defined conversion has occurred or applying the mixture to a substrate or introducing it into a mold and allowing the reaction to take place on the substrate or in the mold. In addition, it is also possible to apply the mixture to a substrate or introduce it into a mold by means of an in-situ mixing process, with the further reaction to form the polyurethane then occurring on the substrate or in the mold. The resulting polyurethane can optionally be processed further in downstream reactions by, for example, carrying out chain extension by means of polyamines in the case of free isocyanate groups or else allowing a reaction with atmospheric moisture to occur so as to give polyurethane ureas. An overview of such processes may be found in the Kunststoffhandbuch [Plastics Handbook], vol. 7, Polyurethane; Becker, Braun and Oertel, Hanser Verlag, (1993).

The above-described polyurethanes can be employed in a variety of applications, especially as shaped bodies, elastomers, adhesives, coatings, films, sealants and fibers. These are described, inter alia, in the volumes of the Kunststoffhandbuch (see above) or in: Polyurethane: Lacke, Kleb and Dichtstoffe; Meier-Westhues, Vincentz-Verlag, (2007).

The working examples below merely serve to illustrate the invention. They are not intended to restrict the scope of protection of the claims in any way.

### EXAMPLES

### Methods and Terms

Hydroxyl number: The determination of the OH number was carried out according to the method of DIN 53240-1 (method without catalyst, June 2013 version).
Acid number was determined in accordance with DIN EN ISO 2114 (June 2002).
Viscosity: Dynamic viscosity: Rheometer MCR 51 from Anton Paar in accordance with DIN 53019-1 (September 2008 version) using a measuring cone CP 50-1, diameter 50 mm, angle 1° at shear rates of 25, 100, 200 and 500 s⁻¹. The polyols according to the invention and those which are not according to the invention display viscosity values which are independentofthe shear rate.
Shore hardness: DIN ISO 7619-1; February 2012 version
König pendulum hardness: DIN 55945; 2016-08 Stress 100%, stress 300%, rupture stress and elongation at break: DIN 53504 (Oct. 1, 2009 version)
Index: Designates the molar ratio of NCO groups to NCO-reactive groups multiplied by 100 in a formulation
Proportion of secondary OH end groups: Quantitative ¹³C-NMR, in deuterochloroform, TMS=0 ppm, Bruker AV III HD 600 MHz spectrometer.

Production of the Polyester Polyols

(Production of the Polyester Polyol Ex. A-1:

1534.4 g (10.5 mol, corresponds to 53.32 parts by weight) of adipic acid and 1343 g (11.369 mol, corresponds to 46.68 parts by weight) of hexanediol were placed in a 4 liter four-neck flask equipped with mechanical stirrer, 50 cm Vigreux column, thermometer, nitrogen inlet and also column head, distillation bridge and vacuum membrane pump and were heated under a blanket of nitrogen to 200° C. over a period of 60 minutes, with water of reaction distilling off above a temperature of about 150° C. After about 3 hours, the elimination of water of reaction ceased. The reaction was completed by adding 24 ppm of tin(II) chloride dihydrate, lowering the pressure stepwise by application of vacuum over a period of about 2 hours to a final value of 15 mbar and continuing the reaction at 200° C. for a further 15 hours.

Analysis of the Polyester:

Hydroxyl number: 41.1 mg KOH/g

Acid number: 0.5 mg KOH/g

Viscosity: 1600 mPas at 75° C.

Proportion of secondary OH end groups: not detectable

TABLE 1
Synthesis and properties of polyester polyols according to the invention and not
according to the invention (C = comparison)

| Example | | A-1 | A-2(C) | A-3(C) | B-1 | B-2(C) | B-3(C) |
|---|---|---|---|---|---|---|---|
| Formulation: | | | | | | | |
| Adipic acid | [% by weight] | 53.32 | 53.34 | 53.36 | 59.65 | 59.65 | 59.65 |
| 1,6-hexanediol | [% by weight] | 46.68 | 44.66 | 41.64 | | | |
| 1,4-cyclohexanediol | [% by weight] | | 2.0 | 5.0 | | | |
| 1,4-butanediol | [% by weight] | | | | 40.35 | 38.35 | 35.35 |
| 2,3-butanediol | [% by weight] | 2.0 | 5.0 | | | | |
| Tin(II) chloride* | [ppm] | 24 | 24 | 24 | 20 | 20 | 20 |
| 2H₂O | | | | | | | |
| Analysis: | | | | | | | |
| OH number | [mgKOH/g] | 41.1 | 38.3 | 39.8 | 51.3 | 50.9 | 50.4 |
| Acid number | [mgKOH/g] | 0.5 | 0.7 | 1.0 | 0.5 | 0.3 | 0.3 |
| Viscosity at 75° C. | [mPa*s] | 1600 | 1920 | 2350 | 1290 | 1080 | 1110 |
| Proportion of | [mol %] | 100 | 92 | 81 | 100 | 90 | 74 |
| primary OH | | | | | | | |
| end groups | | | | | | | |
| Proportion of | [mol %] | Not | 8 | 19 | Not | 10 | 26 |
| secondary | | detectable | | | detectable | | |
| OH end groups | | | | | | | |

The polyester polyols A-2(C) and A-3(C) were produced by a method analogous to that described for example A-1.

In the case of the polyester polyols B-1 to B-3(C), it is necessary, in view of the lower boiling point of 1,4-butanediol compared to 1,6-hexanediol, to compensate for the loss of OH groups in the selected procedure by addition of further 1,4-butanediol and subsequent equilibration (180° C., 6 hours stirring at atmospheric pressure) in order to obtain the OH numbers indicated in table 1.

In accordance with expectations, table 1 shows that only the polyester polyols A-1 and B-1 have virtually exclusively primary hydroxyl end groups. The comparative examples A-2(C), A-3(C), B-2(C) and B-3(C) have, in the light of the small amounts of diol having secondary hydroxyl groups used, surprisingly high proportions of secondary hydroxyl end groups, as discussed below:

In example A-2(C), a total of 756.9 mmol of primary hydroxyl groups in the form of 1,6-hexanediol and 34.5 mmol of secondary hydroxyl groups in the form of 1,4-cyclohexanediol are used; the proportion of secondary hydroxyl groups is thus 34.5/(34.4+756.9)*100=4.3 mol %. In the polyester polyol, there are, at 8 mol % a disproportionately large number of secondary hydroxyl groups relative to the starting mixture. It is clear from this that the proportion of impurities such as cyclohexanediol, for production of a polyester polyol having a defined proportion of secondary hydroxyl groups based on the total amount of terminal hydroxyl groups cannot be determined by simple stoichiometric calculations.

Production of the Polyurethanes

To produce the polyurethanes, the polyesters indicated in table 1 are crosslinked using a commercial polyisocyanate (Desmodur N3300) in a ratio of (NCO/OH=1.0). To give suitable test specimens, a levelling agent (Byk 302; 0.1% by weight) and a catalyst customary for this reaction (DBTL, 10% in butyl acetate; 0.02% by weight based on solids content) is used.

The production of the 2-component systems and test specimens based on the polyesters and the polyisocyanate was carried out according to the following detailed formulation and the working steps described below:

| | |
|---|---|
| Polyester | 174.68 g |
| Desmodur N 3300 | 24.72 g |
| DBTL, 10% strength in butyl acetate | 0.40 g |
| BYK 302 | 0.2 g |
| Total | 200.00 g |

The polyester is weighed into a suitable vessel and heated to 80° C. The polyisocyanate (Desmodur N 3300) is likewise preheated to 80° C. and added in a ratio of NCO:OH=1:1 with manual stirring.

Calculation: 247=(% of OH)/(% of NCO)=m [g] of isocyanate per 100 g of polyol

The catalyst DBTL at 0.02% (based on solids content) and Byk 302 at 0.1% (based on solids content) are added immediately after addition of the polyisocyanate and homogenization and stirred vigorously but with as few bubbles as possible.

The crosslinked systems are then processed immediately:

The systems were applied in a wet film thickness of 500 μm by means of a doctor blade to a glass plate and a carrier plate for free films.

The applied surface coating films are heated at 80° C. in a convection oven for 16 hours.

After heating of the glass plates, these are conditioned at room temperature (about 23° C.) for about 1 hour. The layer thickness is then measured and the surface coating film is assessed according to further criteria.

To determine the Shore hardness, a further test specimen is cast. For this purpose, the crosslinked system is applied without bubbles in a plastic lid having a diameter of about 6 cm and likewise heated at 80° C. for 16 hours. The resulting test specimen should have a diameter of at least 35 mm and a thickness of at least 6 mm. Before the use tests, all test specimens are conditioned for a sufficient time under standard conditions (for polymers, 23° C., 50% relative atmospheric humidity).

Testing of the Shore hardnesses, the König pendulum hardness and the procedure for the tensile elongation tests are carried out in accordance with the basic standards known to a person skilled in the art.

TABLE 2
Results of the use testing of coatings obtained from
the above-described polyurethanes

| | | | König pendulum | | Tensile |
|---|---|---|---|---|---|
| | | | hardness | | test |
| | | | After | After | 100% |
| | Shore hardness | | 16 hours | 7 days | modulus |
| | Shore A | Shore D | [s] | [s] | [N/mm²] |
| A-1 | 86 | 41 | 80 | 80 | 9.42 |
| A-2(C) | 80 | 34 | 68 | 69 | 6.01 |
| A-3(C) | 77 | 22 | 52 | 59 | 4.57 |
| B-1 | 68 | 20 | 134 | 150 | 6.10 |
| B-2(C) | 62 | 19 | 136 | 138 | 4.15 |
| B-3(C) | 55 | 16 | 112 | 104 | 2.27 |

Valuation by linear regression indicates:

A1 to A3:

Decrease in Shore D: 2.4% per mol % of secondary OH group; R²=1.00

Decrease in pendulum hardness: 1.4% per mol % of secondary OH group; R²=0.98

B1 to B3:

Decrease in Shore D: 0.7% per mol % of secondary OH group; R²=0.97

Decrease in pendulum hardness: 1.13% per mol % of secondary OH group; R²=0.97

The exceptionally high correlation coefficients show that there is a very close relationship between the content of secondary OH groups and weakening of the mechanical properties, so that the effects observed can also be reliably extrapolated for very small differences in the content of secondary OH groups.

1. A polyester polyol having a proportion of secondary OH groups based on a total amount of terminal OH groups of not more than 2 mol %.

2. A polymerizable composition comprising at least one polyester polyol as claimed in claim 1 and at least one polyisocyanate.

3. (canceled)

4. (canceled)

5. (canceled)

6. (canceled)

7. (canceled)

8. A process for producing polyurethane polymers having a particularly high hardness, comprising
a) mixing the polyester polyol as claimed in claim 1 with at least one polyisocyanate to form a reaction mixture;
b) curing the reaction mixture to give a polyurethane polymer.

9. The process as claimed in claim 8, wherein an alcohol component of the polyester polyol comprises at least 90% by weight of 1,6-hexanediol and the polyurethane polymer has a Shore D hardness which is at least 7% above a value measured when using an otherwise identical polyester polyol having a proportion of secondary OH groups based on the total amount of terminal OH groups of at least 5 mol %.

10. The process as claimed in claim 8, wherein an alcohol component of the polyester polyol comprises at least 90% by weight of 1,4-butanediol and the polyurethane polymer has a Shore D hardness which is at least 3% above a value measured when using an otherwise identical polyester polyol having a proportion of secondary OH groups based on the total amount of terminal OH groups of at least 5 mol %.

11. The process as claimed in claim 8, wherein the reaction mixture formed in process step a) is applied to a surface before curing in process step b).

12. A polyurethane polymer obtained by the process as claimed in claim 8.

13. The process as claimed in claim 8, wherein an alcohol component of the polyester polyol comprises at least 90% by weight of 1,4-butanediol and the polyurethane polymer has a Shore D hardness which is at least 4% above a value measured when using an otherwise identical polyester polyol having a proportion of secondary OH groups based on the total amount of terminal OH groups of at least 5 mol %.

14. The process as claimed in claim 8, wherein an alcohol component of the polyester polyol comprises at least 90% by weight of 1,6-hexanediol and the polyurethane polymer has a König pendulum hardness which is at least 2% above a value measured when using an otherwise identical polyester polyol having a proportion of secondary OH groups based on the total amount of terminal OH groups of at least 5 mol %.

15. The process as claimed in claim 8, wherein an alcohol component of the polyester polyol comprises at least 90% by weight of 1,4-butanediol and the polyurethane polymer has a König pendulum hardness which is at least 3% above a value measured when using an otherwise identical polyester polyol having a proportion of secondary OH groups based on the total amount of terminal OH groups of at least 5 mol %.
